(19) United States
(12) Patent Application Publication
(10) Pub. No.: US 2024/0317614 A1
(43) Pub. Date: Sep. 26, 2024

(54) CHEMICAL REACTOR SYSTEMS AND METHODS FOR GENERATING CHLORINE DIOXIDE

(71) Applicant: Clear World Corporation, Rego Park, NY (US)

(72) Inventors: Boris Davidoff, Old Westbury, NY (US); Johannes Verwater, Merritt Island, FL (US)

(21) Appl. No.: 18/368,974

(22) Filed: Sep. 15, 2023

Related U.S. Application Data
(60) Provisional application No. 63/454,148, filed on Mar. 23, 2023.

(51) Int. Cl. C02F 1/467; C02F 1/461

(52) U.S. Cl. CPC C02F 1/4674; C02F 1/46109; C02F 2001/46133; C02F 2001/46171; C02F 2201/4612; C02F 2201/46175; C02F 2201/46185; C02F 2209/29; C02F 2301/024; C02F 2303/04

(57) ABSTRACT

A chemical reactor unit is provided that includes first and second circulation loops and an anode arranged between the first and second circulation loops. A first cathode is located at a beginning of the first circulation loop and a second cathode is located at an end of the second circulation loop. The chemical reactor unit can be used to generate a chlorine dioxide solution. A method for generating a chlorine dioxide solution includes applying a voltage differential between first and second cathodes and an anode arranged therebetween and pumping a fluid mixture comprising sodium chlorite and oxalic acid to sequentially pass the first cathode, the anode, and the second cathode. An apparatus is additional provided that includes a tank configured to hold a fluid mixture, a chemical reactor unit, and a pump configured to circulate the fluid mixture between the tank and the chemical reactor unit.

### CROSS-REFERENCE TO RELATED APPLICATIONS

This application claims priority to U.S. Provisional Patent Application No. 63/454,148, filed on Mar. 23, 2023, the entire contents of which are hereby expressly incorporated by reference in their entirety.

### INTRODUCTION

The present disclosure is directed to chemical reactor systems and methods for producing chlorine dioxide (ClO₂).

### SUMMARY

Chlorine dioxide can be generated using a number of different methods. In accordance with the present disclosure, chlorine dioxide is generated using an aqueous solution of sodium chlorite and oxalic acid in a chemical reaction unit. More particularly, the chlorine dioxide is generated using a low current that prevents or reduces cavitation at and degradation of the anode.

In some embodiments, the present disclosure is directed to a chemical reactor unit for generating, for example, chlorine dioxide. The chemical reactor unit comprises a first circulation loop, a second circulation loop, and an anode arranged between the first and second circulation loops such that current flows from the anode to the first and second cathodes. The beginning of the first circulation loop comprises a first cathode and the end of the second circulation loop comprises a second cathode. The chemical reactor unit may include or be coupled to a power supply configured to provide a voltage differential between the anode and the first and second cathodes. In some embodiments, the voltage differential is between 50 and 1,500 volts, the power supply is configured to cause up to 1 amp of current to flow through the circulation loops, and/or the power supply is configured to generate a pulsed (e.g., square) wave having the voltage differential between 50 and 1,500 volts and having a frequency between 0.1 and 500 hertz. The pulsed wave may be a square wave.

In some embodiments, the beginning of the first circulation loop and the end of the second circulation loop are coupled to a tank and the power supply is a floating supply and electrically grounded to the tank. In some embodiments, a pump is configured to circulate fluid between the tank and the chemical reactor unit, where the fluid comprises a mixture of sodium chlorite and oxalic acid, and where the chemical reactor unit is configured to generate a chlorine dioxide solution of at least 3,000 parts per million (PPM). The fluid can be water to which the chemicals have been added.

In some embodiments, the first cathode comprises a first cylindrical cathode through which fluid is configured to flow to enter the first circulation loop, and the second cathode comprises a second cylindrical cathode through which the fluid is configured to flow to exit the second circulation loop. In some embodiments, the chemical reactor unit further comprises a first orifice ring arranged upstream of the first cylindrical cathode and configured to create turbulence in the fluid flowing past the first cylindrical cathode, and a second orifice ring arranged upstream of the second cylindrical cathode and configured to create turbulence in the fluid flowing past the second cylindrical cathode.

In some embodiments, a distance between the first cathode and the anode is approximately the same as a distance between the second cathode and the anode, and the distance is between 5 and 50 feet. In some embodiments, the first circulation loop and the second circulation loop are each made of piping having a diameter of 1 inch (or, in some embodiments, between 0.5 and 2.0 inches). The loop distances and diameters can be chosen so as to cause, for a given power supply voltage, a low current (e.g., up to 1 amp with 1-inch diameter piping) to flow through the fluid. In some embodiments, the low current can be greater than 1 amp when the diameter of the piping is greater than 1-inch. In some embodiments, for a given loop distance, the upper limit of the low current is proportional to the cross-sectional area of the piping. Preferably, the upper limit is chosen so as to avoid excess degradation of the anode.

In some embodiments, the chemical reactor unit includes a housing, where the first cathode, the second cathode, and the anode are arranged within the housing, and a portion of each of the first and second circulation loops extends outside of the housing.

In some embodiments, the first cathode, the second cathode, and the anode are each made of stainless steel 316L, and the first circulation loop and the second circulation loop are each made of PVC piping.

In some embodiments, the present disclosure is directed to a method of generating chlorine dioxide dissolved in a fluid (preferably, water) by applying a voltage differential between first and second cathodes and an anode arranged therebetween (e.g., centrally) and pumping a fluid mixture comprising sodium chlorite and oxalic acid to sequentially pass the first cathode, pass through a first circulation loop between the first cathode and the anode, pass the anode, pass through a second circulation loop between the anode and the second cathode, and pass the second cathode. The voltage differential is sufficient to cause a current (e.g., up to 1 amp with 1-inch tubing), to flow through the fluid. The method may further include using a first orifice ring arranged upstream of the first cathode to create turbulence in the fluid mixture flowing past the first cathode, and using a second orifice ring arranged upstream of the second cathode to create turbulence in the fluid mixture flowing past the second cathode.

In some embodiments, the method of applying the voltage differential between first and second cathodes and the anode comprises applying a square wave between first and second cathodes and the anode having a voltage between 50 and 1,500 volts and a frequency between 0.1 and 500 hertz.

In some embodiments, the present disclosure is directed to an apparatus comprising a tank configured to hold a fluid mixture, a chemical reactor unit, and a pump configured to circulate the fluid mixture between the tank and the chemical reactor unit, where the chemical reactor unit comprises first and second cathodes and an anode arranged (e.g., centrally) between the first and second cathodes such that current flows from the anode to the first and second cathodes. In some embodiments, the apparatus also includes a mixer configured to mix contents of the tank and a sensor configured to detect chlorine dioxide concentration. In some embodiments, the fluid mixture comprises sodium chlorite and oxalic acid and the apparatus further comprises a power supply configured to provide a voltage differential between the anode and the first and second cathodes, while the pump is circulating the fluid mixture, to generate a chlorine dioxide solution of at least 3,000 parts per million (PPM).

In some embodiments, the present disclosure is directed to a method comprising pumping a fluid mixture comprising sodium chlorite and oxalic acid to pass through a circulation loop between an anode and a cathode and applying a voltage differential between the anode and the cathode that causes current to flow through the fluid mixture to increase a chlorine dioxide reaction rate without sacrificing the anode. In some embodiments, the fluid mixture naturally reacts to generate chlorine dioxide and wherein the voltage differential causes a higher total amount of chlorine dioxide to be generated than what would be generated from natural chemical reactions and Faraday's Law.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a block diagram of a chemical reactor system including a chemical reactor unit, in accordance with some embodiments of the present disclosure;

FIG. 2A shows a graph of the generation of chlorine dioxide produced using different power supply settings, in accordance with some embodiments of the present disclosure;

FIG. 2B shows a graph of the stability of the chlorine dioxide concentrations depicted in FIG. 2A, in accordance with some embodiments of the present disclosure; and

FIG. 3 shows the chemical reactor unit of FIG. 1, in accordance with some embodiments of the present disclosure.

### DETAILED DESCRIPTION

There are different methods for generating chlorine dioxide. One difference between the different methods is the number of chemicals or precursors required to generate the chlorine dioxide. Apart from chemicals used, other differences include the efficiency of the reaction, the chlorine dioxide yield, and/or weight of chlorine dioxide that the method can practically accomplish. Using photometric or electrolytic methods, only one chemical, sodium chlorite (NaClO2), is required.

Other methods use two precursors, such as sodium chlorite (NaClO₂) plus chlorine gas (Cl2) as follows:

$$2 NaCl {O}_{2} + {Cl}_{2} \to 2 C l {O}_{2} + 2 NaCl$$

or sodium chlorite (NaClO₂) plus hydrochloric acid (HCl) as follows:

$$5 NaCl {O}_{2} + 4 HCl \to 4 Cl {O}_{2} + 5 NaCl + 2 {H}_{2} O .$$

Other methods involve three precursors, sodium chlorite (NaClO₂) plus sodium hypochlorite (NaOCl) plus hydrochloric acid (HCl) as follows:

$$2 NaCl {O}_{2} + N aOCl + 2 HC1 \to 2 C l {O}_{2} + 3 NaCl + {H}_{2} O$$

or using sodium chlorate (NaClO₃) plus hydrogen peroxide (H₂O₂) plus sulfuric acid (H₂SO₄) as follows:

$$2 N a C l {O}_{3} + {H}_{2} {O}_{2} + {H}_{2} S {O}_{4} \to 2 C l {O}_{2} + N {a}_{2} S {O}_{4} + {O}_{2} + 2 {H}_{2} O$$

A potential route to minimize risks associated with precursors and chlorine dioxide generation would be the use of solid precursors, as opposed to a concentrated liquid or gas precursor. In order to consider the use of material in a solid form, one can initially look at the reaction of sodium chlorite with hydrochloric acid more generically as follows:

$$Chlorite + Acid \to ClO 2 + Sodium Salt + Water$$

To activate sodium chlorite organic as well as, inorganic acids can be used. There are two basic approaches. The first approach is a stabilized solid “chlorine dioxide release” tablet, which is activated by dissolving in water. These are typically used for sterilizing water for drinking when on outdoor activities such as sailing, hiking or camping where water supply of potable quality cannot be guaranteed. The other approach is the use of a powdered precursor which lends itself to the production of stable chlorine dioxide solution. This approach is commercially available using sodium chlorite and sodium bisulfate as separate powdered precursors as follows:

$$5 NaCl {O}_{2} + 4 N a H S {O}_{3} \to 4 C l {O}_{2} + 4 N {a}_{2} S {O}_{4} + NaCl + 2 {H}_{2} O .$$

In accordance with the present disclosure, oxalic acid is used to generate chlorine dioxide as follows:

$$4 NaCl {O}_{2} + 2 {C}_{2} H 2 {O}_{4} \to 4 C l {O}_{2} + 2 N {a}_{2} {C}_{2} {O}_{4} + 2 {H}_{2} ,$$

where the powdered precursors are mixed into an aqueous solution and processed using new chemical reactor systems and methods.

In accordance with some embodiments of the present disclosure, the two powdered precursors are mixed together to produce at least 0.3% solution of chlorine dioxide (i.e., 3,000 PPM ClO₂) in water. The precursors themselves may have a shelf life of at least 5 years and the generated 0.3% solution of chlorine dioxide is stable having a kinetic half-life greater than 30 days. The chlorine dioxide solution can then be dosed directly from the preparation vessel, using, for example, normal metering dosing pumps, directly to the system or area for use (e.g., for disinfecting). Although the resulting solution of chlorine dioxide is stable, some chlorine dioxide may exist in gas or vapor phases above the solution. In some embodiments, the dosing unit vents back into the preparation vessel to reduce exposure to chlorine dioxide gas or vapor.

Chlorine dioxide is a strong and selective oxidizer and offers several advantages in treatment and distribution of drinking water, and other industrial applications using disinfection. For example, chlorine dioxide forms fewer halogenated disinfection by products (DBP)s, and can be used at lower concentrations and shorter contact times to achieve disinfection than is required for other chemicals such as chlorine. It is also less reactive to changes in pH than chlorine and has been proven more effective over a broader range of pH than free chlorine. Chlorine dioxide has been utilized in Europe and the U.S. as both the primary disinfectant and pre-oxidant with around 1,200 plants currently implementing its disinfection for drinking water facilities. The selective reactivity enables chlorine dioxide to control waterborne pathogens without reacting with organic DPB precursors. Unlike chlorine, chlorine dioxide reactions in water do not result in the formation of total trihalomethanes (TTHMs) and haloacetic acids (HAAs). Chlorine dioxide can be applied for a variety of water quality issues, including disinfection by-product formation control, taste and odor issues, or nitrification in the distribution system especially in distribution systems where water age with long dead-end mains is a concern. The use of chlorine dioxide can be tailored to a specific facility's need, and can be used as the primary disinfectant or as a preliminary oxidant followed by chlorine or chloramines in a wide variety of applications. Chlorine dioxide has been shown to have five times stronger oxidation potential and disinfection efficacy then chlorine.

A growing number of industries are relying on the superior disinfection and environmentally friendly properties of chlorine dioxide. Chlorine dioxide is used in municipal drinking water to reduce the risk of pathogenic infection but also to control taste, odor, and color and to minimize the disinfection by products in their water supplies. Chlorine dioxide is also superior to chlorine when operating above a pH of 7, when in the presence of ammonia and amines, and for the control of biofilms in water distribution systems. Chlorine dioxide can also be used as a biocide for cooling towers, wastewater treatment, and food processing.

Chlorine dioxide is also effective against anthrax, cysts and protozoa including cryptosporidium, giardia, MERSA, and amoeba. In the food and poultry industry, chlorine dioxide is used to prevent salmonella and e-coli from contaminating meat and poultry, fruits, and vegetables for human use.

When compared with other oxidizing biocides, chlorine dioxide has a significantly lower oxidation strength, which means that it reacts with fewer compounds, such as organic compounds and ammonia, yet is strong enough to attack the disulfide bonds found in the membrane of bacteria and other biological material. Thus, it allows for disinfecting areas quickly and at lower dose rates, leading to much better efficiencies.

In accordance with some embodiments of the present disclosure, a stable liquid form of chlorine dioxide is generated at an affordable price per volume using sodium chlorite and oxalic acid. In some embodiments, stable chlorine dioxide is generated in a reactor having an anode and cathode and a power supply that generates a low current between the anode and cathode. In some embodiments, the power supply provides pulse power at a low current to generate a higher concentration of chlorine dioxide.

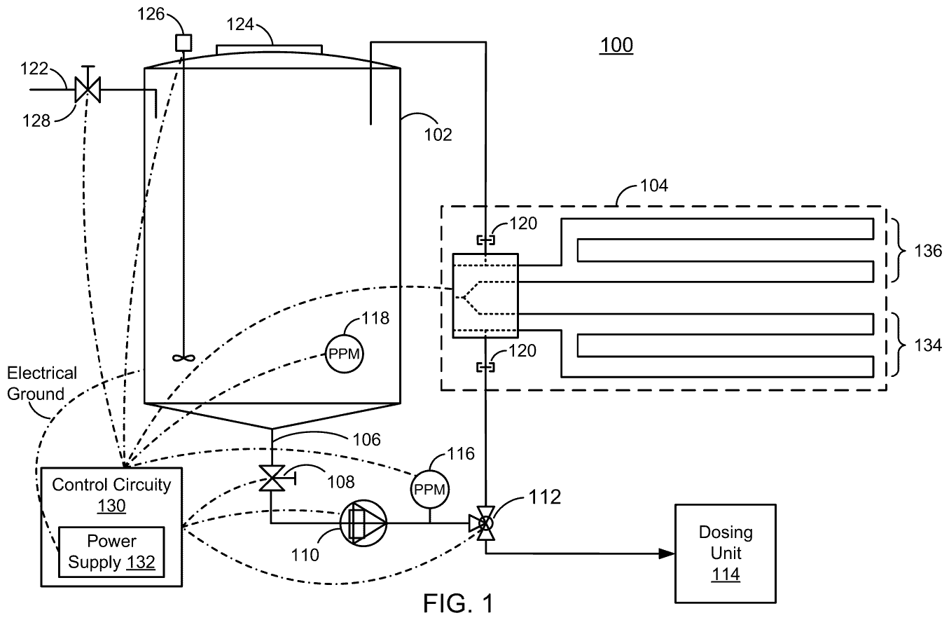

FIG. 1 shows a block diagram of a chemical reactor system 100 in accordance with some embodiments of the present disclosure. In some embodiments, system 100 is used to generate chlorine dioxide. System 100 comprises a tank 102 and a chemical reactor unit 104 that is coupled to tank 102. Tank 102 may be of any size and made of any chemically-compatible material. In some embodiments, tank 102 is between 5 liters and 5,000 liters (e.g., 500 liters or 1,000 liters) and the tank is a polyethylene or polyvinyl chloride (PVC) tank. Chemical reactor unit 104 is coupled to the tank using a piping system that may include one or more pumps, one or more shut-off valves, one or more three-way valves, one or more sensors, one or more disconnects, one or more bypasses, any other components, or any combination thereof.

As illustrated, the piping system includes a drain line 106 from tank 102 that passes through a shut-off valve 108 to a pump 110. Pump 110 is configured to pump fluid from tank 102 to a three-way valve 112. Pump 110 may be any suitable pump that operates at any suitable flow rate, depending on the specific application. In some embodiments, pump 110 is configured to pump between 0.1 and 50 cubic meters of fluid per hour. When three-way valve 112 is set to circulation, the fluid passes through chemical reactor unit 104 and back to tank 102, thereby circulating fluid through system 100. When three-way valve 112 is set to discharge, the fluid is discharged from system 100 to, for example, a dosing unit 114 for subsequent use. The piping system may include a chlorine dioxide sensor, a temperature sensor, a pH sensor, any other sensor, or any combination thereof. As illustrated, a chlorine dioxide (PPM) sensor 116 is positioned between pump 110 and chemical reactor unit 104. It will be understood that the sensors may be positioned at other locations within the piping system or within tank 102. For example, chlorine dioxide sensor 116 can be located between the discharge side of chemical reactor unit 104 and tank 102 and a second chlorine dioxide sensor 118 can be located on tank 102 so that a comparison can be made between the chlorine dioxide concentration in tank 102 and the chlorine dioxide concentration leaving chemical reactor unit 104. As another example, only a single chlorine dioxide PPM sensor may be used in the tank.

In some embodiments, one or more disconnects can be included in the piping system to enable convenient servicing and replacement of components. For example, disconnects 120 can be used inside or outside of the chemical reactor unit to facilitate servicing of the unit.

The piping system returns the fluid passing through chemical reactor unit 104 back to tank 102. For example, the fluid may be returned to an upper portion of tank 102 to enable the returned fluid to mix with the fluid in tank 102 before being recirculated to chemical reactor unit 104. In some embodiments, the piping system is made using PVC pipes.

As illustrated, tank 102 includes a fill line 122, a hatch 124, a mixer 126, and chlorine dioxide sensor 118. Fill line 122 is used to provide a fluid (e.g., water, filtered water, reverse osmosis (RO) water, deionized water, etc.) to tank 102. Fill line 122 includes a valve 128 that controls the flow of fluid. Hatch 124 provides access to the inner volume of tank 102 and can be used for adding one or more chemicals or precursors. Mixer 126 is configured to thoroughly mix the contents of tank 102.

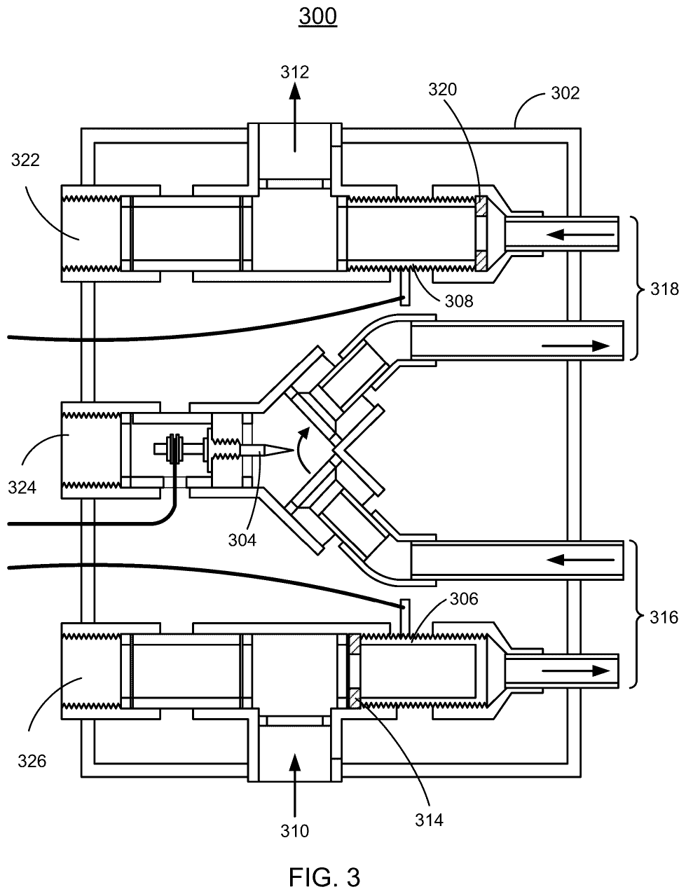

The components of system 100 may be manually or automatically operated. In some embodiments, some of the components are manually operated while other components are automatically operated using control circuitry 130. As shown, control circuitry 130 can be communicatively coupled to the valves 108 and 128, sensors 116 and 118, mixer 126, pump 110, and chemical reactor unit 104. System 100 also includes a power supply 132, which may be part of, or separate from, control circuitry 130. Power supply 132 provides a voltage differential to chemical reactor unit 104, which includes two circulation loops 134 and 136 and which will be described in more detail in connection with FIG. 3.

Control circuitry 130 may include hardware, software, or both, implemented on one or more modules configured to provide control of the components of system 100. In some embodiments, control circuitry 130 includes one or more microprocessors, microcontrollers, digital signal processors, programmable logic devices, field-programmable gate arrays (FPGAs), application-specific integrated circuits (ASICs), or any suitable combination thereof. In some embodiments, control circuitry 130 is distributed across more than one processor or processing units. In some embodiments, control circuitry 130 executes instructions stored in memory (e.g., non-transitory computer readable media) for managing the production of chemicals, such as chlorine dioxide, using system 100. In some embodiments, the memory is an electronic storage device that is part of the control circuitry. For example, the memory may be configured to store electronic data, computer instructions, applications, firmware, or any other suitable information, such as chemical processing instructions and for storing sensor measurements for later retrieval. In some embodiments, buttons or other user interface elements may be provided to enable an operator to interact with the control circuitry.

In an illustrative example, system 100 may be used for generating chlorine dioxide. The process may begin by filling tank 102 with water, such as reverse osmosis-treated (RO) water that has a lower conductivity than regular water. In some embodiments, more consistent results are achieved using RO-treated water. Once tank 102 is filled with the desired volume of water, fill line valve 128 is turned off. Additionally, the starting chemicals (e.g., sodium chlorite and oxalic acid) are added in appropriate quantities or ratios to the water (e.g., using the hatch). For example, in some embodiments, graduated containers are used to premeasure appropriate quantities of the starting chemicals. In some embodiments, mixer 126 is used to thoroughly mix the water and chemicals inside tank 102 before pump 110 is turned on.

Once the fluid mixture is ready, the piping system valves 108 and 112 are opened and set to circulate, pump 110 is turned on, and power supply 132 provides a voltage differential to chemical reactor unit 104 to generate chlorine dioxide in the chemical reactor unit. In some embodiments, a flow sensor is included in the piping system to serve as a safety for the power supply. For example, control circuitry 130 can monitor the flow sensor to detect whether there is fluid flow and only turn on power supply 132 when fluid flow is detected. Control circuitry 130 can then monitor the one or more chlorine dioxide sensors (e.g., sensors 116 and 118) and continue the process until an appropriate level of chlorine dioxide is generated (e.g., 3,500 PPM) or for a predetermined amount of time (e.g., 1 hour). In summary, a method for generating a chlorine dioxide solution comprises applying a voltage differential between first and second cathodes and an anode arranged therebetween (e.g., centrally) in chemical reactor unit 104, and pumping a fluid mixture comprising sodium chlorite and oxalic acid to sequentially pass the first cathode, pass through a first circulation loop 134 between the first cathode and the anode, pass the anode, pass through a second circulation loop 136 between the anode and the second cathode, and pass the second cathode, as described in more detail in connection with FIG. 3.

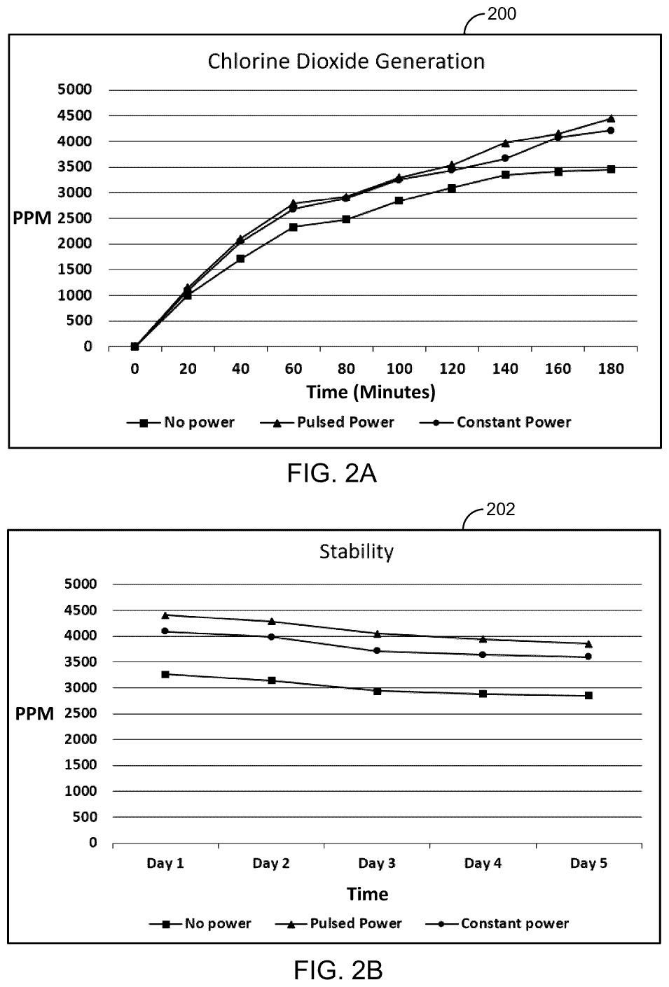

The circulation time to complete the chemical process can vary based on the fluid mixture strength, the quantity of the fluid mixture, the power setting of the power supply, and the configuration of the chemical reactor unit. In some embodiments, power supply 132 provides a voltage differential between 50 and 1,500 volts such that a current of 1 amp or less of current flows through chemical reactor unit 104. Power supply 132 may produce a floating output, in which case power supply 132 should be grounded as shown in FIG. 1. The actual current flowing through chemical reactor unit 104 generated by power supply 132 will be based on the voltage differential, the electrical conductivity of the fluid mixture, and the configuration of the chemical reaction unit. A constant-current power supply may be used to set a desired current, with the voltage varying as necessary to produce the current depending on the electrical conductivity (EC) of the fluid in the loop. Each application has its own circulation time and may have different power supply settings. In some embodiments, power supply 132 provides direct current (DC) voltage depending on the application to the chemical reactor unit. The DC voltage will be guided by the electric conductivity of the water and chemicals in the circulation. In some embodiments, power supply 132 will pulse a current setting (e.g., a 50% duty cycle square wave or sawtooth wave having a frequency between 0.1 and 500 hertz) into chemical reactor unit 104. In an illustrative example, a constant-current power supply provides an approximately 600 volt, 50% duty cycle pulsed DC current of about 0.8 amps through the liquid of chemical reactor unit 104 (e.g., when using circulation loops having an inner diameter of 1 inch). In some embodiments, the pulse frequency is preferably chosen to expedite the generation of ClO₂ at a desired 3,000-3,500 PPM that remains stable in solution. Operating the reaction system at such a low current advantageously increases the lifetime of the anode by preventing or greatly reducing anode degradation as compared to traditional electrochemical reactions that utilize high currents, while the magnetic field produced by the low current flowing through the fluid speeds up the chlorine dioxide reaction rate and increases the concentration of chlorine dioxide produced. As discussed with respect to FIG. 2, the low current is facilitated for a given power supply voltage by providing loops of the chemical reaction unit of suitable length so as to provide an appropriate electrical resistance of the fluid mixture to the flow of current in the loop pipes between the anode and the cathodes.

Once the chlorine dioxide generation process is complete, as determined by a chlorine dioxide PPM detector (e.g., sensor 116 and/or 118) in communication with control circuitry 130 (which may include a programmed processor) or as determined by a timer, control circuitry 130 of system 100 may set three-way valve 112 in the piping system to discharge and pump the fluid to dosing unit 114, which may be a storage tank. For example, chlorine dioxide having a concentration of 3,000-3,500 PPM may be pumped to dosing unit 114 for subsequent use, such as for disinfecting potable water. In some embodiments, a venting pipe (not shown) is used to vent dosing unit 114 back to tank 102.

A solution of sodium chlorite and oxalic acid in water naturally reacts to generate an amount of chlorine dioxide. However, by using system 100 operating at a low constant current on such a solution, the reaction rate can be increased and a higher yield of chlorine dioxide achieved within a given period of time (e.g., 1 hour). Further, by using pulsed power at low current, an even higher yield of chlorine dioxide can be achieved within the given time. Notwithstanding this increased rate of production, the relative stability of the chlorine dioxide in solution is maintained.

FIG. 2A shows a graph 200 of the generation of chlorine dioxide in solution of RO water using different settings of the power supply in FIG. 1. Sodium chlorite and oxalic acid are dissolved in 50 liters of water in a ratio of 20 gr/liter NaClO₂ and 10 gr/liter of oxalic acid. The water is pumped through the reactor loops at a flow rate of 15 gallons per minute. The “no power” plot shows the generation (PPM, vertical axis) over time (in minutes, horizontal axis) of chlorine dioxide with the power supply off (i.e., no current). The “constant power” plot shows the generation of chlorine dioxide with the power supply producing approximately 600 volts to cause about 0.8 amps of current constantly to flow. The third plot, labeled “Pulsed Power,” shows the generation of chlorine dioxide using the same constant power settings but with the current pulsed on and off (square wave) at a 50% duty cycle. Power is maintained for both the pulsed and constant power cases for 60 minutes, at which time the power is turned off. As FIG. 2A shows, pulsed power produces the highest levels of chlorine dioxide in solution within the period of time (180 minutes) depicted by plot, with constant power providing less chlorine dioxide than using pulsed power. Both pulsed power and constant power produce significantly more chlorine dioxide than the no power case. Also as can be seen in FIG. 2A, the pulsed and constant power concentrations of chlorine dioxide appear still on an upward trajectory at 180 minutes, while the no power concentration appears to be nearly at its maximum. It should be noted that the maximum concentrations of chlorine dioxide reached in FIG. 2A are illustrative, and greater than would be considered preferable in a commercial environment of, e.g., a water-treatment facility in which chlorine dioxide water is produced for use with a municipality's water supply. Reducing the maximum concentration of chlorine dioxide to 3000-3500 ppm for such use can be accomplished for a given amount of water in the supply tank by reducing the amount of precursor chemicals and/or reducing the amount of time power is applied and/or diluting the water. More generally, the concentration of produced chlorine dioxide can be managed for a given type and amount of fluid to be processed by changing (increasing or decreasing) the amount of precursor chemicals and correspondingly adjusting the amount of current and/or time period over which power is applied.

FIG. 2B shows a graph 202 of the stability of the chlorine dioxide concentrations depicted in FIG. 2A, starting 24 hours later (labeled “Day 1”). The “no power” plot shows the stability of chlorine dioxide produced naturally from a solution of sodium chlorite and oxalic acid over the course of 24 hour periods using the reactor of FIG. 1 without applying power. As shown, the “no power” plot starts at day 1 (24 hours after the 180 minute point of FIG. 2A) at a concentration of less than 3,500 PPM (having fallen from the level shown at the 180 minute point of FIG. 2A), and the “no power” concentration is the lowest of the three plots over the 5 days. The “pulsed power” plot shows the stability of chlorine dioxide generated by the “pulsed power” plot of FIG. 2A, with “day 1” again being 24 hours after the 180 minute mark of FIG. 2A so that the solution of sodium chlorite and oxalic acid produced by a 1 hour application of pulsed power has been allowed to stabilize thereafter for 26 hours. As shown, the “pulsed power” plot has the highest concentration of chlorine dioxide and remains above 3,500 PPM for the entire 5 days. Finally, the “constant power” plot shows the stability of chlorine dioxide generated by the “constant power” plot of FIG. 2A, in which constant power at low current is applied for 60 minutes to a solution of sodium chlorite and oxalic acid, waiting 26 hours for the solution to stabilize. As shown, while the “constant power” plot remains above 3,500 PPM for the entire 5 days, it has a lower concentration than the “pulsed power” plot. The stability plots were generated based on the solutions of chlorine dioxide being stored at an ambient temperature of about 25 degrees Celsius.

In view of the foregoing, it can be seen that pumping a fluid such as water containing sodium chlorite and oxalic acid through an elongated loop between cathode and anode advantageously allows using a relatively high voltage to cause a low current to flow through the fluid rather than high currents as would ordinarily be used in electrochemistry. Using a low current has several advantages. The electromagnetic field produced by the low current is believed to increase the production rate and concentration of chlorine dioxide over a given period of time as compared to what would be produced by natural chemical reaction of the precursor chemicals alone without application of power. Less power is used resulting in decreased cost for equipment, lower energy usage, and increased safety. In addition, for a desired concentration of chlorine dioxide produced, a smaller amount of precursor chemicals can be used and/or a shorter period of time may be needed to produce the chlorine dioxide. What's more, the low current prevents or reduces cavitation at and degradation of the anode (e.g., by reducing or preventing oxidation of the anode and/or other chemical reactions at the anode). This prevents unnecessary sacrificing of the anode.

The total increased production of chlorine dioxide due to the application of a low current in the system of FIG. 1 is more than would be expected from Faraday's law applicable to electrochemistry. All the reactions above are redox reactions. This means chlorine dioxide can also be produced by using electrochemistry. This is the main electrochemical anode reaction:

$${ClO}_{2}^{-} + 4 Cl {O}_{2} + 1 e$$

Faraday's law can be used to calculate the amount of chlorine dioxide that will be produced at a given current for a given amount of time:

$$m = I * t * M / z * F ,$$

where:
m=grams of chlorine dioxide
t=time (sec.)
I=current (A)
M=molar mass (gr/mol) of the substance
z=number of monovalent ions per substance
F=Faraday constant (9.648533×10 4 C/mol).
   Using a system like FIG. 1, with a power supply providing about 600V and a low current of about 0.8 A through a fluid containing dissolved sodium chlorite (NaClO₂) and oxalic acid, where a concentration of chlorine dioxide is produced with power applied for one hour, Faraday's Law will produce a negligible amount (about 1% or less) of that chlorine dioxide. As can be seen in FIG. 2A, this insignificant amount, when added to the amount of chlorine dioxide produced by natural chemical reaction (no power applied), results in an amount of chlorine dioxide significantly less than the concentration of sodium dioxide produced by application of the low current (whether constant or pulsed).

In view of the foregoing, it can be seen that applying a low current to an aqueous solution of sodium chlorite and oxalic acid speeds up the generation of chlorine dioxide and results in a higher total amount of chlorine dioxide being generated, even after the power supply is turned off, than would be expected from natural chemical reactions and Faraday's Law. In addition, pulsing the power can produce an even higher concentration. This is counterintuitive. Pulsing the power using a 50% duty cycle square wave uses half the energy of constant power, yet results in chlorine dioxide to be generated at the same or even a higher rate and a higher total amount than constant power. Pulsed power induces a varying magnetic field. It is believed that the varying current and magnetic field results in molecular agitation of the aqueous solution in a way that facilitates the generation of chlorine dioxide not only during the agitation, but also for hours later until the solution stabilizes. Higher currents such as used in traditional electrochemistry will not meaningfully improve the generation of chlorine dioxide and instead will disadvantageously cause the anode to be sacrificed (e.g., degrade at a high rate) and unnecessarily increase energy usage.

In some embodiments of the present disclosure, chlorine dioxide is generated using a circulation loop between an anode and cathode (e.g., one of circulation loops 134 and 136 of FIG. 1). For example, a fluid mixture comprising sodium chlorite and oxalic acid is passed through the circulation loop between the anode and the cathode and a voltage differential is applied between the anode and cathode. The voltage potential is selected such that a current is caused to flow (e.g., a low current) through the fluid mixture to increase the chlorine dioxide reaction rate of the fluid mixture without sacrificing the anode. In some embodiments, the voltage differential also causes a higher total amount of chlorine dioxide to be generated than what would be generated from natural reactions.

FIG. 3 shows an exemplary embodiment of chemical reactor unit 104 of FIG. 1, in accordance with some embodiments of the present disclosure. As shown, chemical reactor unit 300 includes a housing 302 that encloses an anode centrally 304 arranged between first and second cathodes 306 and 308. In some embodiments, housing 302 is made from standard schedule 80 PVC (e.g., having a Teflon coating). Fluid enters chemical reactor unit 300 at inlet 310 shown on the bottom and exits at outlet 312 at the top. The fluid flows through chemical reactor unit 300 as follows: the fluid passes a first orifice ring 314, passes first cathode 306, passes through a first circulation loop 316, passes centrally arranged anode 304, passes through a second circulation loop 318, passes a second orifice ring 320, and passes second cathode 308. First orifice ring 314 is arranged upstream of the first cathode chamber and is configured to create turbulence in the fluid flowing past first cathode 306. Similarly, second orifice ring 320 is arranged upstream of the second cathode chamber and is configured to create turbulence in the fluid flowing past second cathode 308. As shown, first cathode 306 is a cylindrical cathode through which the fluid flows and second cathode 308 is a cylindrical cathode through which the fluid flows. The inner cathode surface of first cathode 306 may start immediately or shortly after orifice ring 314 and may end at or before the inner surface begin to taper. The inner cathode surface of second cathode 308 may start immediately or shortly after orifice ring 320 and may end at or before the chamber before outlet 312. In some embodiments, the orifices may not be included.

First and second circulation loops 316 and 318 each comprise a length of piping (not shown) to provide separation between anode 304 and the first and second cathodes 306 and 308. Depending on the length of first and second circulation loops 316 and 318, the loops may extend outside of housing 302 and may include a serpentine flow path to reduce the packaging space (e.g., as can be seen in FIG. 1 in reference to circulation loops 134 and 136). In some embodiments, the length of circulation loops 316 and 318 is such that a distance (e.g., flow distance) between anode 304 and first and second cathodes 306 and 308 is between 5 and 50 feet. In some embodiments, the length of circulation loops 316 and 318 is such that the distance between first and second cathodes 306 and 308 and anode 304 is between 10 and 25 feet. The separation may provide one or more benefits. For example, when the fluid passes first orifice ring 314, turbulence is generated in the fluid flow. By using a sufficiently long length of piping in the first circulation loop 316, the turbulence can be corrected and the fluid flow can be stabilized before entering the next reaction stage or chamber. As another example, using longer circulation loops enables higher voltages to be used without corresponding increases in the current. To illustrate, if the length of a circulation loop is doubled and the voltage is doubled, the current will remain approximately the same because the resistance of the fluid is proportional to the length of the circulation loop. As another example, by using longer circulation loops, the fluid will be in the presence of electrical current and a resultant magnetic field for a longer amount of time, which may increase the reaction rate. In some embodiments, the piping diameter in first and second circulation loops 316 and 318 is smaller than the piping leading to and from chemical reaction unit 300. In some embodiments, the piping diameter in first and second circulation loops 316 and 318 is the same size as the piping leading to and from chemical reaction unit 300. In some embodiments, the piping diameter of first and second circulation loops 316 and 318 is between 0.5 and 2.0 inches.

As mentioned above, anode 304 is arranged (e.g., centrally) between first and second cathodes 306 and 308 (e.g., in an anode reaction chamber as shown) such that current flows from the anode to the first and second cathodes. This arrangement provides safety benefits. For example, by positioning anode 304 between first and second cathodes 306 and 308, electrical current and voltage can be attenuated or prevented from affecting the tank (e.g., tank 102). In some embodiments, the power supply (e.g., power supply 132) may be grounded to the tank or the fluid within the tank. The power supply can then provide a voltage differential such that first and second cathodes 306 and 308 are electrically coupled to ground and the voltage differential is applied to anode 304. Such an arrangement will inhibit the tank from becoming electrically charged even when high voltages are used within the chemical reactor unit 300.

The housing of chemical reactor unit 300 also includes side openings 322-326 to accommodate servicing and/or cleaning of the housing and the components within. During operation, side openings 322-326 are closed and sealed for safety reasons and to prevent liquid from entering or leaving housing 302.

First and second cathodes 306 and 308 and the anode 304 are electrically connected to a power supply (e.g., as shown in FIG. 1). In some embodiments, electrical connectors are used to make the connections to the power supply. In some embodiments, the cables connected to first and second cathodes 306 and 308 are first joined together and a single connector is used to electrically connect the first and second cathodes to the power supply. In some embodiments, the cables connected to first and second cathodes 306 and 308 use separate connectors and are separately connected to the power supply. In some embodiments, the power supply generates a high voltage induced electromagnetic field between anode 304 and first and second cathodes 306 and 308 inside the chemical reactor unit 300. In some embodiments, anode 304 is made of stainless steel 316L. In some embodiments, the first and second cathodes 306 and 308 are also made of stainless steel, for example 316L. In some embodiments, first and second orifice rings 314 and 320 are also made of stainless steel, for example 316L. Orifice rings 314 and 320 may be positioned near their respective cathodes, but spaced away such that they are not electrically coupled to their respective cathodes.

It will be understood that while chemical reactor system 100 and the chemical reactor unit 300 have been described above in reference to generating chlorine dioxide, chemical reactor system 100 and the chemical reactor unit 300 can be used for performing other electrochemical reactions. For example, the use of an anode arranged as disclosed between two cathodes in system 100 and chemical reactor unit 300 provides improved safety functionality that can be applied to other electrochemical reactions.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A chemical reactor unit, comprising
a first circulation loop;
a first cathode located at a beginning of the first circulation loop;
a second circulation loop;
a second cathode located at an end of the second circulation loop; and
an anode arranged between the first and second circulation loops such that current flows from the anode to the first and second cathodes.

2. The chemical reactor unit of claim 1, further comprising:
a power supply configured to provide a voltage differential between the anode and the first and second cathodes.

3. The chemical reactor unit of claim 2, wherein the voltage differential is between 50 and 1,500 volts.

4. The chemical reactor unit of claim 2, wherein the power supply is configured to cause up to 1 amp of current to flow between the anode and the first and second cathodes through a fluid in the first and second circulation loops.

5. The chemical reactor unit of claim 2, wherein the power supply is configured to generate a square wave having a voltage differential and having a frequency between 0.1 and 500 hertz.

6. The chemical reactor unit of claim 2, wherein:
the beginning of the first circulation loop and the end of the second circulation loop are coupled to a tank; and
the power supply is electrically grounded to the tank.

7. The chemical reactor unit of claim 1, wherein:
the first cathode comprises a first cylindrical cathode through which fluid is configured to flow to enter the first circulation loop; and
the second cathode comprises a second cylindrical cathode through which the fluid is configured to flow to exit the second circulation loop.

8. The chemical reactor unit of claim 7, further comprising:
a first orifice ring arranged upstream of the first cylindrical cathode and configured to create turbulence in the fluid flowing past the first cylindrical cathode; and
a second orifice ring arranged upstream of the second cylindrical cathode and configured to create turbulence in the fluid flowing past the second cylindrical cathode.

9. The chemical reactor unit of claim 1, wherein:
a distance between the first cathode and the anode is approximately the same as a distance between the second cathode and the anode; and
the distance is between 5 and 50 feet.

10. The chemical reactor unit of claim 9, wherein:
the first circulation loop and the second circulation loop are each made of piping having a diameter between 0.5 and 2.0 inches.

11. The chemical reactor unit of claim 1, further comprising:
a housing, wherein:
the first cathode, the second cathode, and the anode are arranged within the housing;
a portion of the first circulation loop extends outside of the housing; and
a portion of the second circulation loop extends outside of the housing.

12. The chemical reactor unit of claim 1, wherein:
the first cathode, the second cathode, and the anode are each made of stainless steel 316L; and
the first circulation loop and the second circulation loop are each made of PVC piping.

13. The chemical reactor unit of claim 1, wherein:
the beginning of the first circulation loop and the end of the second circulation loop are coupled to a tank;
a pump is configured to circulate fluid between the tank the chemical reactor unit;
the fluid comprises a mixture of sodium chlorite and oxalic acid; and
the chemical reactor unit is configured to generate a chlorine dioxide solution of at least 3,000 parts per million (PPM).

14. A method comprising:
applying a voltage differential between an anode and first and second cathodes; and
pumping a fluid mixture comprising sodium chlorite and oxalic acid to sequentially pass the first cathode, pass through a first circulation loop between the first cathode and the anode, pass the anode, pass through a second circulation loop between the anode and the second cathode, and pass the second cathode,
whereby the voltage differential causes a current of less than 1 amp to flow through the fluid mixture to generate a chlorine dioxide solution of at least 3,000 parts per million (PPM).

15. The method of claim 14, further comprising:
using a first orifice ring arranged upstream of the first cathode to create turbulence in the fluid mixture flowing past the first cathode; and
using a second orifice ring arranged upstream of the second cathode to create turbulence in the fluid mixture flowing past the second cathode.

16. The method of claim 14, wherein applying the voltage differential between first and second cathodes and the anode comprises pulsing the voltage differential to cause the current to be pulsed.

17. An apparatus, comprising:
a tank configured to hold a fluid mixture;
a chemical reactor unit; and
a pump configured to circulate the fluid mixture between the tank and the chemical reactor unit,
wherein the chemical reactor unit comprises:
first and second cathodes; and
an anode centrally arranged between the first and second cathodes such that current flows from the anode to the first and second cathodes.

18. The apparatus of claim 17, further comprising:
a mixer configured to mix contents of the tank.

19. The apparatus of claim 17, further comprising:
a sensor configured to detect chlorine dioxide concentration in the fluid mixture.

20. The apparatus of claim 17, wherein the fluid mixture comprises sodium chlorite and oxalic acid, the apparatus further comprising:
a power supply configured to provide a voltage differential between the anode and the first and second cathodes, while the pump is circulating the fluid mixture, to cause a low current to flow through the fluid mixture to generate a chlorine dioxide solution of at least 3,000 parts per million (PPM).
